(19) United States
(12) Patent Application Publication
(10) Pub. No.: US 2003/0211247 A1
(43) Pub. Date: Nov. 13, 2003

(54) Process and apparatus for impregnating media with curable liquids

(76) Inventors: Anton Peter, Lindau (DE); Melanie Maier, Bad Wurzach (DE); Susanne Blendl, Maierhoefen (DE)

Correspondence Address: MCKENNA LONG & ALDRIDGE LLP, Matthew T. Bailey, 1900 K Street, N.W., Washington, DC, 20006, US

(21) Appl. No.: 10/347,509

(22) Filed: Jan. 21, 2003

(30) Foreign Application Priority Data
Jan. 22, 2002 (EP) 02 001 486.6

(51) Int. Cl. B05D 3/02

(52) U.S. Cl. 427/385.5; 118/258

(57) ABSTRACT

Disclosed is a process for the production of paper impregnated with a curable liquid as used in decorative laminated systems. In the present invention, the paper is provided with a curable liquid by foaming the curable liquid and applying the foam to paper to be impregnated, or to an already treated material. Further disclosed is an apparatus for impregnating paper for decorative laminated systems with curable liquids by means of a foam generator, a foam application device for applying curable liquid to the paper, and a dryer for attaining the desired residual moisture content within the applied curable liquid.

This application claims the benefit of European Patent Application No. 02 001 486.6, filed on Jan. 22, 2002, which is hereby incorporated by reference for all purposes as if fully set forth herein

### BACKGROUND OF THE INVENTION

1. Field of the Invention

The present invention relates to a process and apparatus for the impregnation of a media with a curable liquid whereby the curable liquid, if mixed with particles, will yield an even density of particles within the impregnation, enhancing the abrasion resistance and optical qualities of the resulting material.

2. Discussion of the Related Art

The production of decorative laminated systems, such as decorative laminates or decorative laminated panels, involves the impregnation of paper with resins that are curable by various means: heat, UV radiation, IR radiation or electron beams. The laminate or directly coated laminated panel is produced by pressing a plurality of impregnated papers under pressure and heat, with the optical effect usually being achieved with one decorative paper from among the papers. Decorative surfaces can also be produced by means of finish films.

Certain configurations of these laminates involve overlaying papers of different grammage and structure on top of a decorative layer, providing an abrasion resistant surface. Another means of achieving abrasion resistance is through a “liquid overlay” whereby a resin containing abrasive particles is applied directly to the decorative layer.

The liquid overlay approach is less costly since additional impregnated overlay papers are not required. The disadvantage of this approach is that conventional curable liquid impregnation methods generally do not yield sufficiently uniform particle densities to meet high quality requirements.

### SUMMARY OF THE INVENTION

Accordingly, the present invention is directed to a process and apparatus for impregnating a media with curable liquids that substantially obviates one or more of the problems due to limitations and disadvantages of the related art.

It is the object of the invention to more efficiently provide media impregnated with a curable liquid and intended for decorative laminated systems with comparatively higher quality, particularly in relation to the use of hard particles.

This object is achieved by the features of the independent claims. The subclaims describe advantageous and expedient further developments of the invention.

The invention starts from a process for the production of a media impregnated with a curable liquid that are used in the production of decorative laminated systems. Such decorative laminated systems include HPL (High Pressure Laminate), CPL (Continuous Pressure Laminate) and coated laminated panels, and in particular, directly coated laminated panels. In the context of the invention, impregnated media is understood as meaning a particular layer of paper, or a film or foil of various materials, such as plastic or metal. The use of paper that readily absorbs a curable liquid, such as melamine resin, is most frequently associated with decorative media. The core of the invention lies in the fact that the curable liquid is initially foamed, and that the foam is applied to the media to be impregnated. The foam has the property of better penetrating through the corresponding material, due to the lower surface tension of the foam relative to that of the unfoamed liquid. A curable liquid that may be used is, for example, aqueous melamine resin with which additives have been mixed. However, other heat-curable, UV, IR, or electron beam curable liquids are also conceivable.

The foam can be used to a particular advantage if hard mineral particles, e.g. corundum, are mixed into it. The foam then acts as a carrier of these mineral components, which are incorporated in the foam and held in suspension. This makes it possible initially to achieve a balanced distribution of the particles in the foam, and, if the foam is applied uniformly to the surface of a media, achieving a homogenous distribution of particles on the surface. The foam can be applied to an already coated media such as an impregnated paper, or to a raw material such as a base paper. Particles such as corundum are said to impart high abrasion resistance to the media.

The application of hard abrasive particles with the aid of the foam not only has the advantage of achieving homogenous application, but it can additionally achieve a good optical appearance. Moreover, different amounts, sizes and shapes of particles can be easily established in the foam, and hence the layer, enabling the production of surfaces with different abrasion resistances. The foam may have different consistencies of foam weights. The lower the foam weight, the more stable it is, providing for better suspension of the particles.

During foam application, it has been found that the foam, after application to a media such as paper, rapidly collapses into a very homogenous smooth “coating” without undesired bubble formation.

In a preferred embodiment of the invention, the curable liquid is mixed with particles prior to foaming. Thereafter, the mixture is foamed. This ensures homogeneous distribution of the particles.

For further processing, it is as a rule necessary, after the collapse of the foam, for the media provided with the foam to be dried in order to achieve a predefined residual moisture content.

In order to avoid stresses in the media provided with the curable liquid or, in a subsequent pressing process, to avoid wear to the press plates by the abrasive effects of the particles incorporated in the curable liquid, it is moreover proposed to apply at least one further layer of a curable liquid to one or both sides of the media. This additional layer is preferably dried in order to establish a defined residual moisture content. The additional layer increases the abrasion resistance as well as embeds the abrasive particles.

The apparatus comprises a foam generator for producing foam from the curable liquid to be applied. It also comprises a foam applicator, through which the media, e.g. paper, is transported. The foam applicator and foam generator can be realized as a unit. In a preferred embodiment, the foam generator comprises a mixer.

To permit the mixing of additives with the curable liquid, it is furthermore proposed to connect a mixer upstream of the foam generator. By means of the mixer, it is possible to distribute additives, e.g. particles, homogeneously in the curable liquid prior to foam production.

For the suitable curable liquids, but in particular for heat-curable synthetic resins such as melamine resin, the foam formed from the liquid collapses immediately after application to the media surface; only a homogeneous liquid coating remains. In order to prepare this for further processing, it is preferable to connect a dryer downstream of the foam application device. Advantageously, the coated media passes through the dryer.

In a particularly preferred embodiment of the invention, the foam applicator includes a slot-like outlet orifice for applying foam to a surface moving transversely thereto.

Particularly during application of curable liquids with mixed-in particles, it is moreover preferable if a media, e.g. a paper, is pre-impregnated on both sides before foam application. The pre-impregnation step may be integrated into the function of the foam applicator.

In order to permit application of the further layer on an already applied layer of pre-dried curable liquid, it is moreover preferable to if a further curable liquid application device is provided after the foam applicator and dryer. A second dryer is connected to the output of the second curable liquid application. Thus, the media can be conditioned as rapidly as possible for further operation.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 depicts a cross-sectional view of the media after impregnation as implemented by the invention.

FIG. 2 illustrates the apparatus of the present invention.

### DETAILED DESCRIPTION OF THE ILLUSTRATED EMBODIMENTS

Reference will now be made in detail to an embodiment of the present invention, example of which is illustrated in the accompanying drawings.

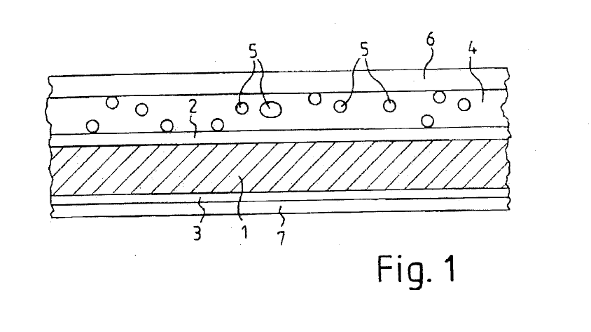

FIG. 1 shows, as a sectional diagram, a paper 1 which can be thoroughly impregnated and/or pre-impregnated on both sides with a synthetic resin layer 2, 3. A further layer 4 containing corundum particles 5 uniformly distributed in the layer is applied to the side facing the user. Particularly high abrasion values are achieved in the layer as a result

In addition, this layer structure is once again provided, on one or both sides, with a layer 6 and/or 7 of synthetic resin, e.g. melamine resin.

A paper 1 coated in this manner is used, for example, for the production of a laminated system which is intended for areas having particularly high abrasion requirements. For example, the laminated system is applied as a laminate to a substrate and is used as a floor element or as a tabletop having particularly high mechanical resistance.

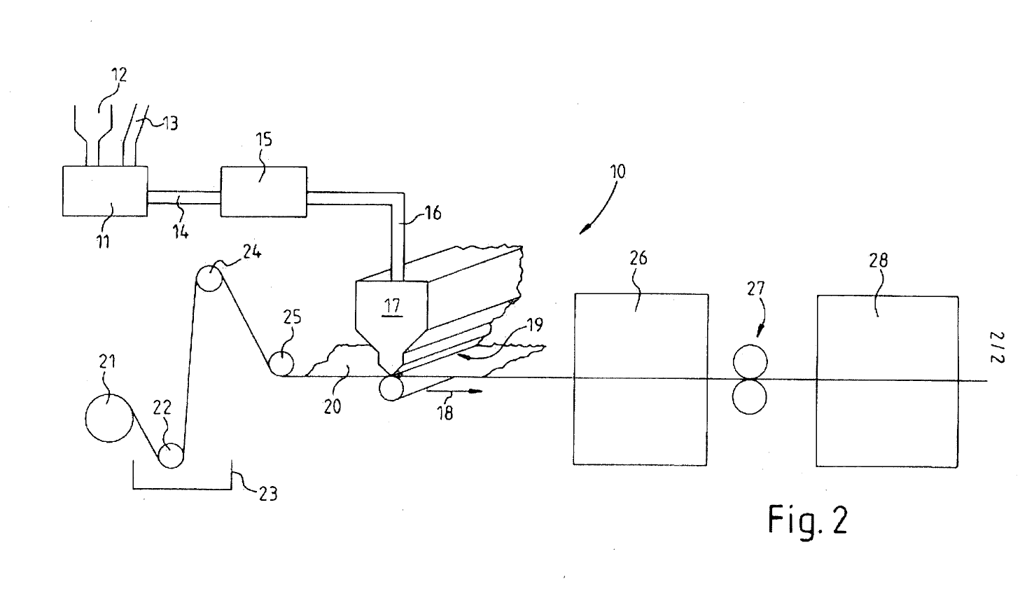

FIG. 2 shows the schematic diagram of an apparatus 10 for the production of impregnated paper according to FIG. 1.

The apparatus 10 comprises a mixer 11 having a feed piper 12 for, for example, corundum particles and a feed pipe 13 for, for example, melamine resin. In the mixer 11, corundum particles and melamine resin are homogenized. The homogenized mixture (also referred to as liquor) is then fed via connection 14 to a mixer 15. In the mixer 15, the liquor is foamed. The foam is transported via a further connection 16 to a foam applicator 17. The foam applicator 17 has a slot-like orifice 19 (in this context, cf. the foam applicator shown schematically in three dimensions) transverse to the coating direction 18.

The foam is applied through the slot-like orifice 19 to a paper web 20 moving past the slot-like orifice 19 in the coating direction 18. The paper web 20 runs from a roller 21 and is first impregnated with, for example, melamine resin, i.e. pre-impregnated on both sides, at a deflection roll 22 in a tray 23. The pre-impregnated paper reaches the application slot of the foam applicator 17 via two further deflection rolls 24, 25.

Here, as described above, the melamine foam thoroughly mixed with corundum is applied to the top of the paper web. The foam collapses before the paper web reaches a dryer 26, in which the melamine resin with corundum particles is dried to a predetermined residual moisture content.

By the use of the melamine foam, it is possible initially to achieve a very high uniformity of density of corundum particles per unit area in the melamine layer. Moreover, as long as the foam has not collapsed, the corundum particles remain in a fixed position in the foam layer. After the foam has collapsed, the melamine resin layer with corundum particles is dried before the latter can settle in a direction perpendicular to the layer, i.e. paper web surface. Thus, a uniform distribution of corundum particles is also achieved over the thickness of the melamine resin layer.

After the dryer, a further melamine resin layer is applied to one of both sides of the paper web by means of a further curable liquid applicator 27 and is dried in a downstream dryer 28 to a predetermined residual moisture content. Furthermore, the paper web 20 can either be rolled up or be cut to a specific dimension in order to be further processed, for example in a press.

The apparatus 10 is to be understood merely by way of example. Individual components of the apparatus are not absolutely essential for producing a layer impregnated according to the invention. For example, it is also conceivable for the impregnation unit 22, 23, to be entirely replaced by a foam application. What is important is to apply foamed synthetic resin which first penetrates better into an applied layer and, second, with the use of mixed-in particles, ensures a uniform distribution of particles in the foam and the subsequent foam-free layer.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A process for impregnating a media with curable liquids comprising:
foaming a curable liquid;
applying the foamed curable liquid to the media, thus impregnating the media; and
drying the impregnated media.

2. The process of claim 1, wherein the media includes decorative paper.

3. The process of claim 1, wherein the curable liquid includes melamine resin.

4. The process of claim 1, further comprising the step of pre-impregnating the media with a curable liquid before applying the foam.

5. The process of claim 1, further comprising the step of mixing the curable liquid with a plurality of particles prior to foaming.

6. The process of claim 5, wherein the particles include a mineral.

7. The process of claim 6, wherein the mineral includes corundum.

8. The process of claim 1, further comprising the step of allowing the foam to collapse after the applying step and prior to the drying step.

9. The process of claim 1, wherein the drying of the impregnated media prevents the particles from settling in an orientation perpendicular to the surface of the media.

10. The process of claim 1, wherein the drying step includes the substep of curing of the impregnated media by one of UV, IR, heat, and electron beam techniques.

11. The process of claim 1, further comprising the step of applying a curable liquid a second time to a side of the media.

12. The process of claim 5, further comprising the step of drying the second application of curable liquid.

13. An apparatus for impregnating thin layers with curable liquids comprising:
a foam generator;
a foam applicator connected to an output of the foam generator; and
a dryer connected to an output of the foam applicator.

14. The apparatus of claim 13, further comprising a mixer which combines a plurality of particles with the curable liquid before the foam generation.

15. The apparatus of claim 13, wherein the foam applicator has a slot-like outlet orifice for applying foam to a surface moving transversely thereto.

16. The apparatus of claim 13, further comprising an applicator that pre-impregnates the media with a curable liquid, placed upstream of the foam applicator.

17. The apparatus of claim 16, wherein the applicator applies the curable liquid to both sides of the media.

18. The apparatus of claim 16, further comprising:
a roller; and
a tray containing curable liquid.

19. The apparatus of claim 13, further comprising an applicator that applies a second layer of curable liquid to the media, connected to the output of the dryer subsequent to the foam applicator.

20. The apparatus of claim 13, further comprising a dryer connected to the output of second curable liquid applicator.
